(19) United States
(12) Patent Application Publication
(10) Pub. No.: US 2025/0333974 A1
(43) Pub. Date: Oct. 30, 2025

(54) BRACKET CONFIGURED TO PROVIDE A COLUMN CONNECTION TO A STRUCTURAL FOUNDATION

(71) Applicant: Atlas Tube Connections, LLC, Chicago, IL (US)

(72) Inventor: Edward Goldstein, Douglaston, NY (US)

(21) Appl. No.: 19/191,547

(22) Filed: Apr. 28, 2025

Related U.S. Application Data
(60) Provisional application No. 63/640,463, filed on Apr. 30, 2024.

(51) Int. Cl. E04H 12/22; B33Y 80/00

(52) U.S. Cl. CPC E04H 12/2269; B33Y 80/00

(57) ABSTRACT

A bracket for connecting a bottom of a column to a foundation including: a base, a plurality of stiffeners extending upward from the base. The bracket moreover includes where each of the plurality of stiffeners includes at least one face configured to attach to an exterior of the column. The bracket also includes where the base includes a plurality of holes around a perimeter of the base. The bracket further includes where each of the plurality of holes are configured to receive corresponding rods extending from the foundation. The bracket in addition includes where the base is substantially flat and configured to be in contact with the bottom of the column.

### CROSS-REFERENCE TO RELATED APPLICATIONS

This application claims the benefit from U.S. Provisional Application No. 63/640,463 filed on Apr. 30, 2024, which is hereby incorporated by reference in its entirety for all purposes as if fully set forth herein.

### FIELD OF THE DISCLOSURE

The disclosure relates to connections of columns to structural foundations. More particularly, the disclosure relates to a connection, such as a bracket, which is configured to connect a column to a structural foundation and distribute the load evenly from the column to the foundation. Further, the disclosure relates to processes of implementing connections of columns to structural foundations. More particularly, the disclosure relates to processes of implementing a connection, such as a bracket, which is configured to connect a column to a structural foundation and distribute the load evenly from the column to the foundation.

### BACKGROUND OF THE DISCLOSURE

Typical column base plate assemblies require welding along an interface between a surface of the base plate and column. In this regard, this interface provides a limited area to provide a structural connection between the bracket and column. Further, typical bracket assemblies are often heavy and require a substantial amount of material and time to manufacture.

Accordingly, a bracket which allows for a stronger connection and/or is configured to be lighter, stiffer, easier to manufacture, and/or made of less material is needed.

### SUMMARY OF THE DISCLOSURE

The foregoing needs are met, to a great extent, by the disclosure, wherein in one aspect an apparatus is provided to implement a bracket configured to connect the end of a column, that column being an HSS (Hollow Structural Section) member, H beam member, I beam member and/or the like, to a structural foundation, such as a concrete foundation. The bracket described herein relates primarily to the connection of vertical columns to structural foundations but is equally applicable to connections of horizontal or diagonal members to foundations. For the purposes of the descriptions that follow, the term “vertical” indicates directions parallel to the long axis of the column, and the term “horizontal” indicates directions that are perpendicular to the long axis of the column.

In one aspect, a bracket includes a base. The bracket in addition includes a plurality of stiffeners extending upward from the base. The bracket moreover includes where each of the plurality of stiffeners comprises at least one face configured to attach to an exterior of the column. The bracket also includes where the base comprises a plurality of holes around a perimeter of the base. The bracket further includes where each of the plurality of holes are configured to receive corresponding rods extending from the foundation. The bracket in addition includes where the base is substantially flat and configured to be in contact with the bottom of the column.

In one aspect, a bracket includes a base. The bracket in addition includes a collar extending upward from the base and configured to have interior horizontal dimensions substantially equal to exterior horizontal dimensions of the column. The bracket moreover includes where the base comprises a plurality of holes around a perimeter of the base. The bracket also includes where each of the plurality of holes are configured to receive corresponding rods extending from the foundation. The bracket further includes where the base is substantially flat and configured to be in contact with the bottom of the column.

In one aspect of the disclosure, the bracket may include a base and a plurality of stiffeners extending upward from the base. Each of the plurality of stiffeners have at least one face configured to attach to an exterior of the column. The base may have a plurality of holes around a perimeter of the base and may be configured to receive a rod extending into the foundation. Further, a portion of the base may be substantially flat and configured to be in contact with the bottom of the column.

In another aspect of the disclosure, the base may further include a plurality of nut bearing surfaces configured to form a seat for each of a plurality of nuts threaded with each of the rods extending into the foundation. Additionally, each of the nut bearing surfaces may surround each of the plurality of holes.

In an additional aspect of the disclosure, each of the plurality of stiffeners have at least one weld edge configured to attach the stiffeners to the exterior of the column by welding. Further, the base may either have a uniform thickness or a variable thickness.

In one aspect of the disclosure, each of the plurality of stiffeners tapers in one or more horizontal dimensions to a smaller dimension as the stiffener extends upward from the base.

In another aspect of the disclosure, the bracket may include a collar extending upward from the base and configured to have interior horizontal dimensions substantially equal to exterior horizontal dimensions of the column. Further the collar may have a top profile configured to attach to the exterior of the column by welding. The collar may also be of variable height.

In a further aspect of the disclosure, the base may include a plurality of ribs on a top surface of the base configured to increase the bending stiffness and/or strength of the base. Additionally, a bottom surface of the base may be flat and configured to be parallel to a top surface of the foundation. Further, the base may include a rim extending upward from the base around an outer edge of the base and may be configured to increase the stiffness of the base.

In one aspect of the disclosure, each of the plurality of holes may pass through one of the plurality of stiffeners. Additionally, each of the plurality of stiffeners may include a cylinder having one of the plurality of holes configured to receive one of the rods extending from the foundation. Further, each cylinder may have a nut bearing surface configured to form a seat for each of a plurality of nuts threaded with the rods, where each of the nut bearing surfaces surround each of the plurality of holes.

In another aspect of the disclosure, the bracket may be formed by casting, forging, or 3D printing. The bracket may be made of a ductile material or metal, such as steel.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 illustrates an isometric view of an aspect of the bracket according to aspects of the disclosure.

FIG. 2 illustrates an isometric view of the bracket of FIG. 1 attached to a column.

FIG. 3 illustrates a side view of the bracket of FIG. 1.

FIG. 4 illustrates a side view of the bracket of FIG. 1 attached to a column.

FIG. 5 illustrates a top view of the bracket of FIG. 1.

FIG. 6 illustrates an isometric view of another aspect of the bracket according to aspects of the disclosure.

FIG. 7 illustrates an isometric view of the bracket of FIG. 6 attached to a column.

FIG. 8 illustrates a side view of the bracket of FIG. 6.

FIG. 9 illustrates a side view of the bracket of FIG. 6 attached to a column.

FIG. 10 illustrates a top view of the bracket of FIG. 6.

FIG. 11 illustrates an isometric view of a third aspect of the bracket attached to a column according to aspects of the disclosure.

FIG. 12 illustrates an isometric view of the bracket of FIG. 1 attached to a column and a foundation.

### DETAILED DESCRIPTION

The disclosure will now be described with reference to the drawing figures, in which like reference numerals refer to like parts throughout. Aspects of the disclosure advantageously provide a bracket 101 configured to connect an end of a column 201, such as an HSS member, I beam member and/or the like, to a structural foundation 211, such as a concrete foundation.

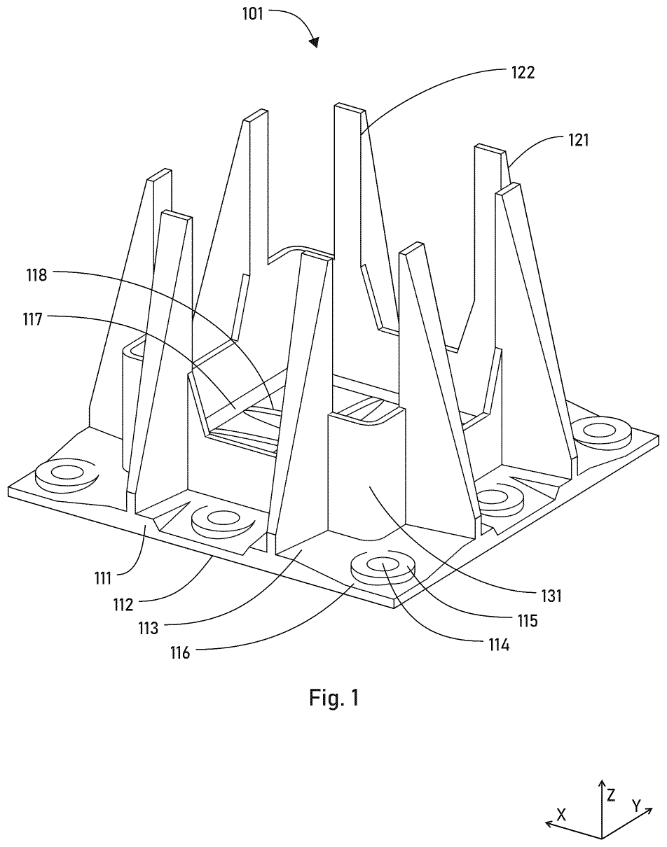

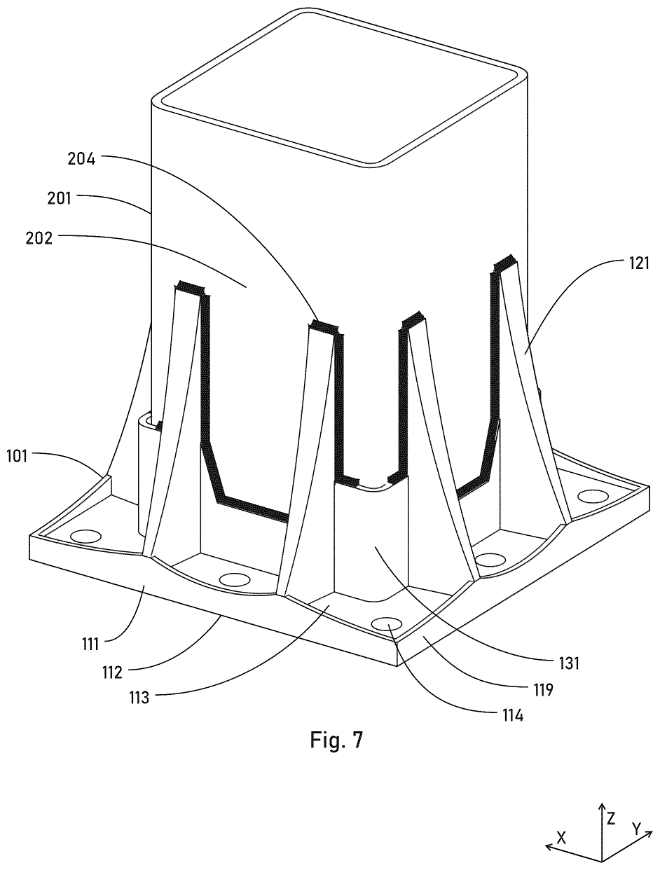

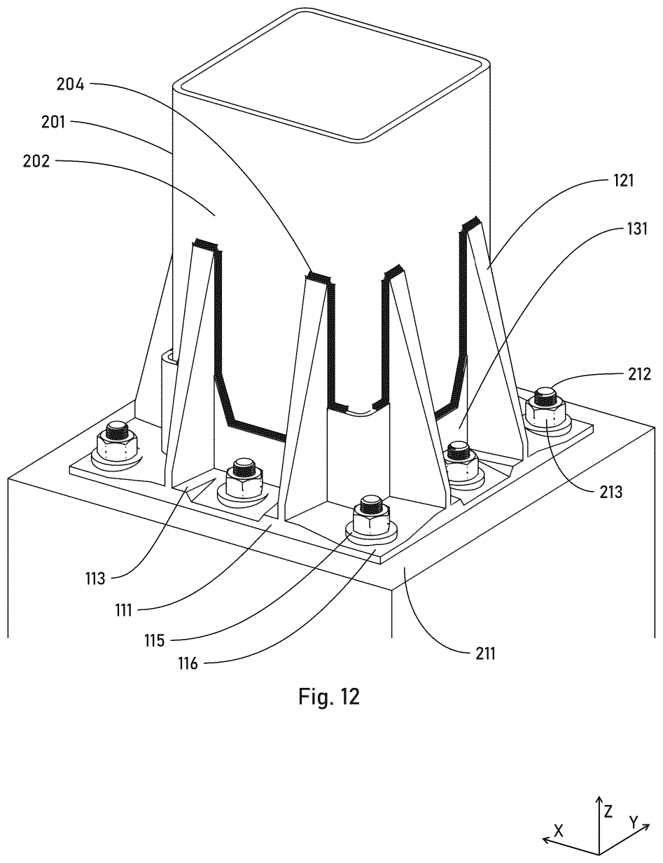

FIGS. 1-12 illustrate the bracket 101 that may be implemented with a base 111, a plurality of stiffeners 121, a collar 131, and/or the like. In aspects, the bracket 101 may be implemented with the plurality of stiffeners 121 and without the collar 131. In aspects, the bracket 101 may be implemented with the collar 131 and without the plurality of stiffeners 121.

In aspects, the plurality of stiffeners 121 may protrude or extend upward from the base 111 and may be configured to attach to exterior faces 202 of the column 201. In aspects, a base of the plurality of stiffeners 121 may extend outwardly toward an edge of the base 111. In aspects, the plurality of stiffeners 121 may have a wider dimension adjacent the base 111 and the plurality of stiffeners 121 may have a narrower dimension distal from the base 111. In other aspects, the plurality of stiffeners 121 may have a substantially consistent width.

In aspects, the plurality of stiffeners 121 may have a curved surface extending from the base 111 toward a distal end of the plurality of stiffeners 121. In aspects, a width of the plurality of stiffeners 121 may be narrower at a perimeter of the base 111 and a width of the plurality of stiffeners 121 may increase toward a center of the base 111 and/or the collar 131. In aspects, the plurality of stiffeners 121 may be formed with the collar 131 as a single structure. In aspects, the plurality of stiffeners 121 may be attached to the collar 131.

The collar 131 may be configured to receive the column 201. In aspects, the collar 131 may have an interior shape and dimensions that may be substantially equal to the exterior dimensions and shape of the column 201. The collar 131 may extend upwards from the base 111.

The bracket 101 may be made of a ductile material, such as a metal. In aspects, the bracket 101 may be made of steel, high-strength steel, aluminum, and/or the like. In aspects, the bracket 101 may be cast. In aspects, the bracket 101 may have a cast construction. Alternatively, the bracket 101 may be machined, 3D printed, forged, and/or the like. In aspects, the bracket 101 may have a forged construction. In aspects, the bracket 101 may have a 3D printed construction.

The base 111 of the bracket 101 may have a bottom surface 112 and an upper surface 113. The bottom surface 112 of the base 111 may be flat and extend farther in dimension along the structural foundation 211 than in dimension along the height of the column 201. That is, the base 111 may be wider in both horizontal directions (along the x-axis and y-axis denoted in the Figures) than in the vertical direction (along the z-axis denoted in the Figures). In other aspects, the base 111 may be configured with a shape consistent with a shape of the structural foundation 211.

The base 111 may also include a plurality of holes 114 configured to accept fasteners. For example, the plurality of holes 114 may be configured to accept threaded rods 212 embedded in the structural foundation 211. A nut bearing surface 115 configured to allow the seating of a nut 213 that is tightened along the threaded rods 212 may surround one or more of the holes. In aspects, the nut bearing surface 115 may include a surface that is perpendicular to an axis of the fastener, such as the threaded rods 212. In aspects, the nut bearing surface 115 may be a portion of the base 111 having an increased thickness with respect to other portions of the base 111.

The upper surface 113 of the base 111 may be contoured to distribute a load from the column 201 evenly to the structural foundation 211 while minimizing the amount of material required for construction of the bracket 101. In this aspect, a weight of the bracket 101 may be reduced while providing sufficient strength.

The plurality of stiffeners 121 may have any shape in aspects, the bottom of the plurality of stiffeners 121 may be angular in shape and may have a sharp or distinct edge between the collar 131 and the upper surface 113 of the base 111 and/or the like. Alternatively, the plurality of stiffeners 121 may have smooth or curved edge sections between the collar 131 and the upper surface 113 of the base 111 so that there is no clear boundary between the stiffeners 121, the base 111, the collar 131 and/or the like. In aspects, each of the plurality of stiffeners 121 may taper to a smaller dimension (along the x-axis and/or y-axis) as the stiffener 121 extends upward from the base 111.

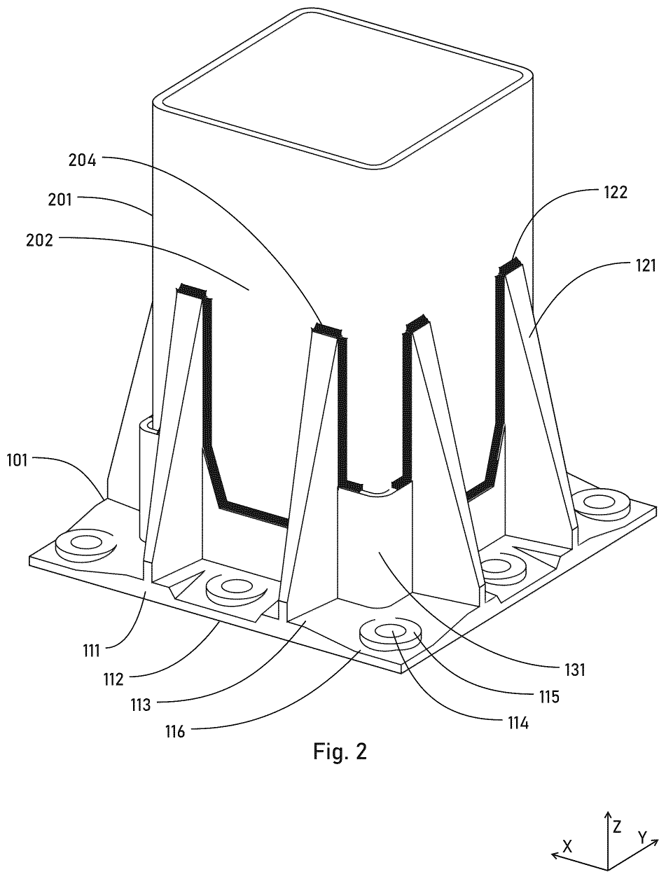

The plurality of stiffeners 121 may have weld edges 122 along the sides that interface with an exterior face 202 of the column 201 as illustrated in FIG. 2. In aspects, the weld edges 122 may be configured to be at substantially right angles to the exterior faces 202 of the column 201 to allow attachment of the bracket 101 to the column 201.

The collar 131 may also have weld edges 122 along a top side that interface with an exterior face 202 of the column 201 in aspects, the weld edges 122 of the collar 131 may be configured to be at substantially right angles to the exterior faces 202 of the column 201 to allow attachment of the bracket 101 to the column 201.

The weld edges 122 of the plurality of stiffeners 121 and/or the collar 131 may be configured to accommodate the welded connections 204. In aspects, the weld edges 122 of the plurality of stiffeners 121 and/or the collar 131 may be configured and arranged in proximity to the column 201. In aspects, the welded connections 204 may form a connection between the bracket 101 and the column 201, the plurality of stiffeners 121 and the column 201, the collar 131 and the column 201. In aspects, welded connections 204 may be fillet welded connections. In other aspects, the welded connections 204 may implement other weld profiles such as groove welds and/or the like.

The weld edges 122 may have a total length greater than a perimeter of a cross section of the column 201, so the welded connections 204 can have a smaller cross section and volume than a weld connecting an end of a column 201 to a traditional prismatic base plate.

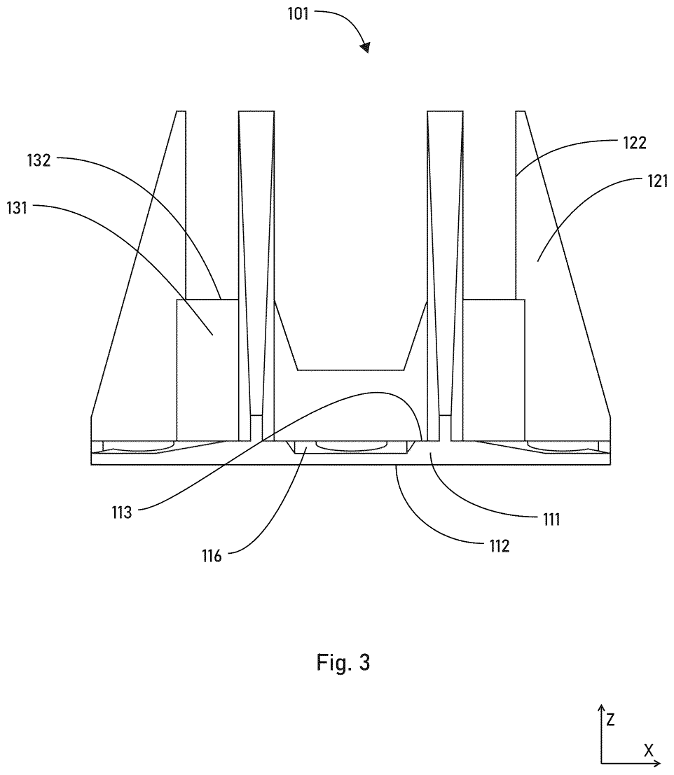

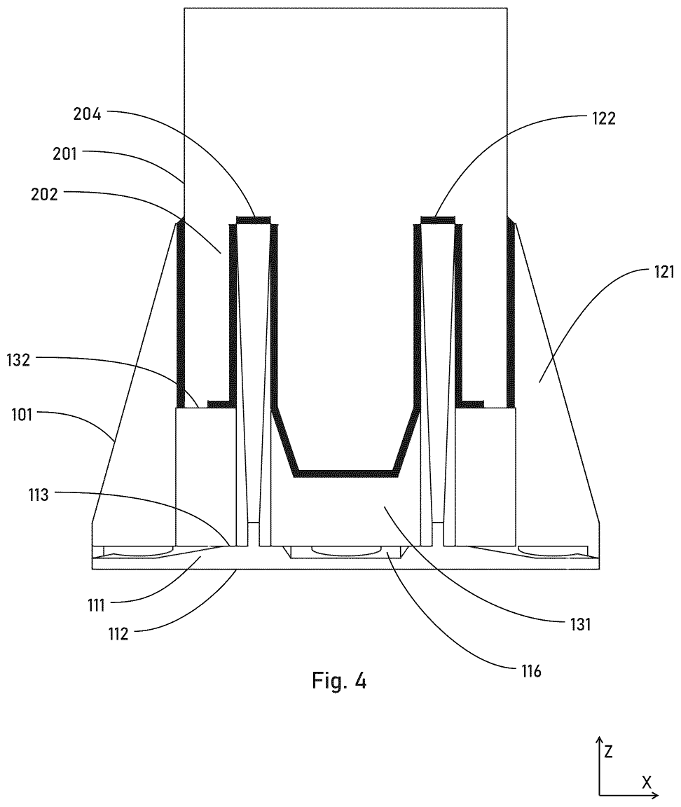

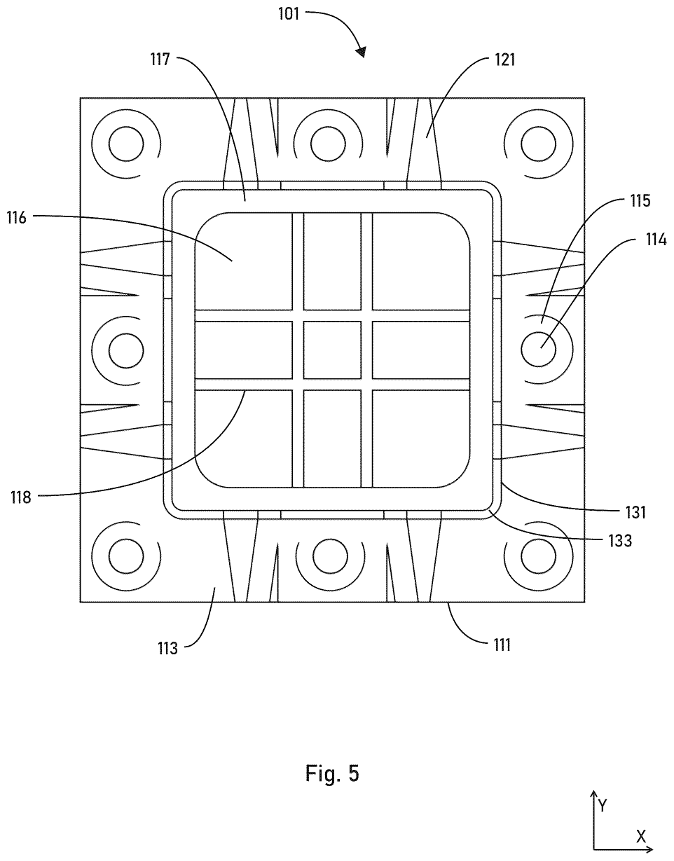

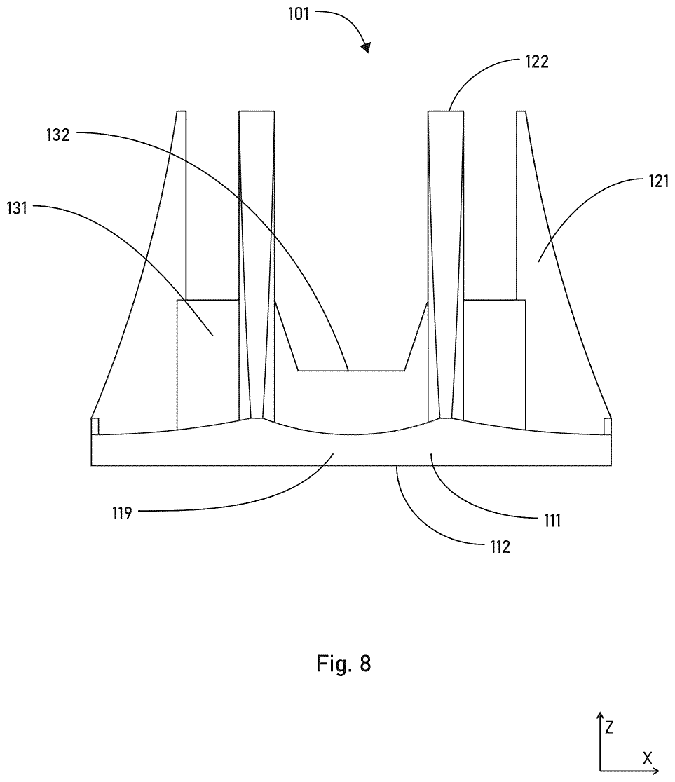

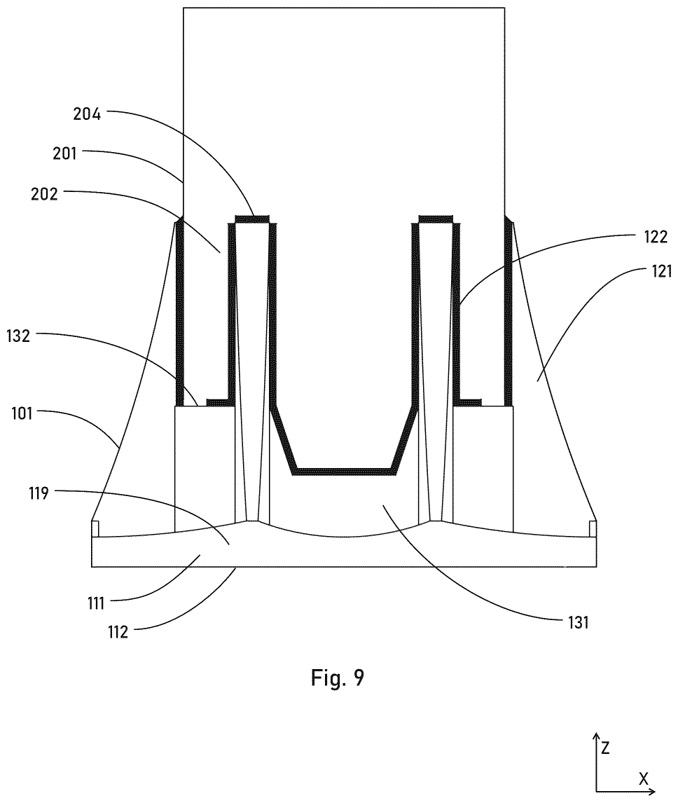

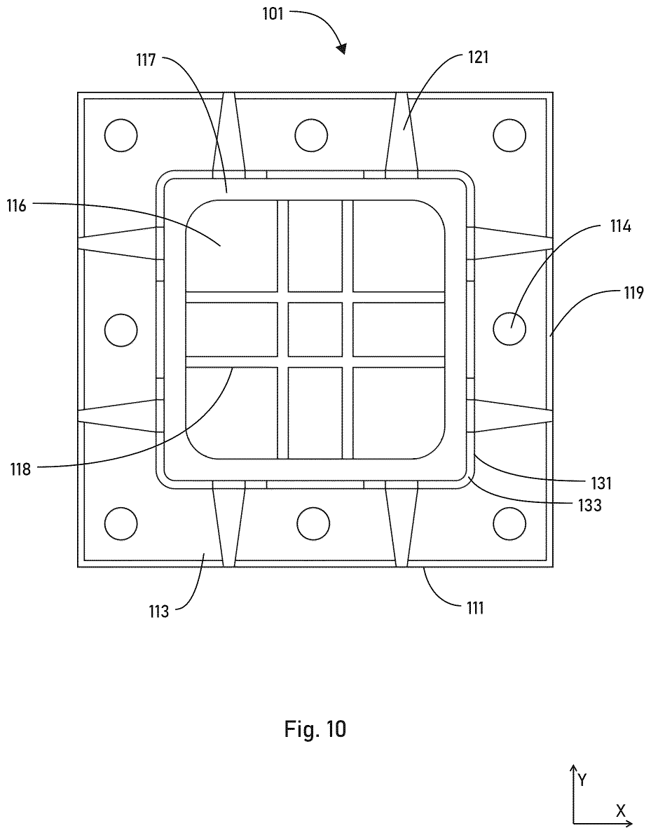

Further, the collar 131 may have a top profile 132 as illustrated in FIG. 3, FIG. 4, FIG. 8, and FIG. 9; and the collar 131 may have corners 133 as illustrated in FIG. 5 and FIG. 10. In aspects, the top profile 132 of the collar 131 may be lower in a center of the bracket 101 interfacing with the column 201 than at the corners 133 interfacing with the column 201. In aspects, the collar 131 may include a plurality of surfaces that extend from a central location up to the plurality of stiffeners 121. In aspects, a construction of the top profile 132 may follow a zig zag path to allow a longer weld to be made. An exemplary version of the top profile 132 is seen in the Figures, but other configurations and shapes of the top profile 132 may be utilized to facilitate welds associated with the welded connections 204 that secure the bracket 101 to the column 201.

Additionally, a plurality of different implementations of the bracket 101 may be configured such that the interior perimeter of the collar 131 may be dimensioned to accommodate the outer perimeter of readily available implementations of the column 201. The brackets 101 may be configured for square columns shown, but can be accommodated for rectangular columns, circular columns, I-shaped columns or beams, H-shaped columns or beams, HSS columns, or and/or the like.

The base 111 may also include a planar, level implementation of the column bearing surface 117. Further, the column bearing surface 117 of the base 111 may be configured to be in direct contact with the bottom of the column 201. This column bearing surface 117 may lie within the inner perimeter of the collar 131.

The area of the base 111 within the inner perimeter of the collar 131 may also include a plurality of thinned areas 116 configured to reduce the total weight of the bracket 101 where stresses may be lower. This area may also include a plurality of ribs 118 to increase the strength and stiffness of the base 111 within this inner perimeter.

The ribs 118 may have an arrangement in the shape of parallel lines crossing one another in a “#” shaped configuration but may be arranged in any shape of lines that cross or run parallel to one another contemplated by a person skilled in the art such as “*” shaped configuration, “X” shaped configuration, “=” shaped configuration, and/or the like. The thinned areas 116 may also be in between the plurality of stiffeners 121 along the outside perimeter of the base 111. Similarly, these thinned areas 116 are configured to reduce the total weight of the bracket 101 where stresses may be lower. The combination of these thinned areas 116 along with the stiffeners 121 and/or the ribs 118 may combine to create a bracket 101 that is lighter, stiffer and/or stronger than a bracket without these features.

In particular, FIGS. 1-5, and 12 show an exemplary aspect of the bracket 101 arrangement in an isometric view, an isometric view attached to the column 201, a side view, a side view attached to the column 201, a top view, and an isometric view attached to a column 201 and a structural foundation 211 respectively. In aspects, the bracket 101 may include a plurality of nut bearing surfaces 115 surrounding each hole 114 and configured to allow the seating of a nut 213 that may be tightened with each of the threaded rods 212.

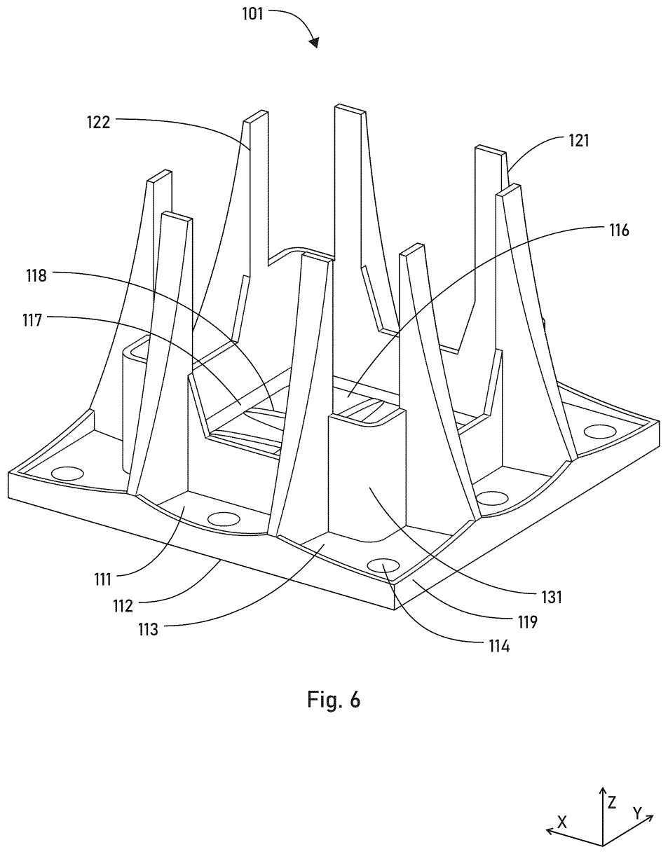

FIGS. 6-10, show an exemplary aspect of the bracket 101 arrangement in an isometric view, an isometric view attached to the column 201, a side view, a side view attached to the column 201, and a top view respectively. The aspect of this bracket 101 may include a rim 119 which extends upward from the base 111 around an outer edge of the base 111 and is configured to increase the stiffness of the base 111.

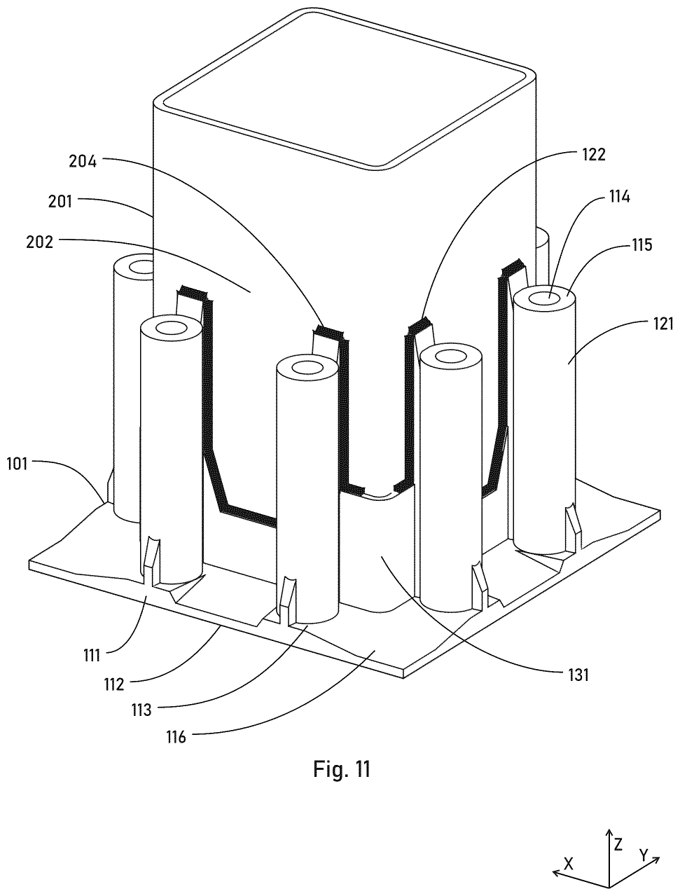

FIG. 11 illustrates an exemplary aspect of the bracket 101 in an isometric view attached to the column 201. In this aspect of the bracket 101, the stiffeners 121 may be implemented as cylinders. The cylinders may include the holes 114 formed within the base 111 and the nut bearing surfaces 115 to allow threaded rods 212 to pass through the stiffeners 121 and the nuts 213 to be seated at a greater height off the top of the structural foundation 211 than would otherwise be available in the previous aspects disclosed. This configuration may provide for better protection to buildings and other structures subject to seismic activity.

In aspects, the bracket 101 may be configured to connect a bottom of the column 201, such as a steel column, to a top of the structural foundation 211. In aspects, the bracket 101 may include the base 111 that extends in both horizontal directions past the column 201 and may be configured to be located between the bottom of the column 201 and the top of the structural foundation 211. In aspects, the bracket 101 may include the plurality of stiffeners 121 that extend upwards from the base 111, each of the plurality of stiffeners 121 having one or more faces configured to be in a same plane as, and attached to, an exterior face of the column 201. In aspects, the bracket 101 may include the plurality of holes 114 in the base 111, each of the plurality of holes 114 may be configured to accept one of a plurality of threaded rods 212 protruding vertically from the structural foundation 211. In aspects of the bracket 101, the base 111 may include a substantially flat and level implementation of the column bearing surface 117 configured to be in direct contact with the bottom of the column 201.

In aspects of the bracket 101, the base 111 may include a plurality of nut bearing surfaces 115 surrounding the plurality of holes 114, the nut bearing surfaces 115 being flat and perpendicular to the threaded rods 212 and configured so that a nut 213 threaded with one of the plurality of threaded rods 212 can seat against one of the plurality of nut bearing surfaces 115. In aspects of the bracket 101, the base 111 may be of uniform thickness. In aspects, the base 111 may be of variable thickness.

In aspects of the bracket 101, the base 111 may include a plurality of ribs 118 on the upper surface 113 of the base 111, the plurality of ribs 118 may increase the bending stiffness and/or bending strength of the base 111. In aspects of the bracket 101, the bottom surface 112 of the base 111 may be flat and configured to be parallel to the top of the structural foundation 211.

In aspects of the bracket 101, the plurality of holes 114 pass through the plurality of stiffeners 121. In aspects of the bracket 101, the plurality of stiffeners 121 may be configured to be attached to the exterior face 202 of the column 201 by welding.

In aspects of the bracket 101, the plurality of stiffeners 121 may be tapered in both horizontal directions. In aspects, the bracket 101 may include a collar 131 that extends upwards from the base 111, the collar 131 configured to have horizontal interior dimensions substantially equal to the horizontal exterior dimensions of the column 201.

In aspects of the bracket 101, the collar 131 may be configured to be attached to one or more of the exterior faces of the column 201 by welding. In aspects of the bracket 101, the height of the collar 131 may be variable.

Accordingly, the disclosure has set forth a bracket that allows for a stronger connection. Further, the disclosure has set forth a bracket that is configured to be a lighter, stiffer, and/or easier to attach to a column.

The following are a number of nonlimiting EXAMPLES of aspects of the disclosure.

One EXAMPLE: a bracket includes a base. The bracket in addition includes a plurality of stiffeners extending upward from the base. The bracket moreover includes where each of the plurality of stiffeners comprises at least one face configured to attach to an exterior of the column. The bracket also includes where the base comprises a plurality of holes around a perimeter of the base. The bracket further includes where each of the plurality of holes are configured to receive corresponding rods extending from the foundation. The bracket in addition includes where the base is substantially flat and configured to be in contact with the bottom of the column.

The above-noted EXAMPLE may further include any one or a combination of more than one of the following EXAMPLES: The bracket of the above-noted EXAMPLE where the base is configured to be in direct contact with the bottom of the column. The bracket of the above-noted EXAMPLE where the base further comprises a plurality of nut bearing surfaces configured to form a seat for each of a plurality of nuts. The bracket of the above-noted EXAMPLE where each of the nut bearing surfaces surround each of the plurality of holes. The bracket of the above-noted EXAMPLE where the bracket is configured such that a plurality of nuts can be threaded with the rods extending from the foundation. The bracket of the above-noted EXAMPLE where the base further comprises a plurality of nut bearing surfaces configured to form a seat for each of a plurality of nuts; where each of the nut bearing surfaces surround each of the plurality of holes; and where the bracket is configured such that a plurality of nuts can be threaded with the rods extending from the foundation. The bracket of the above-noted EXAMPLE where each of the plurality of stiffeners have at least one weld edge configured to attach the stiffeners to the exterior of the column by welding. The bracket of the above-noted EXAMPLE where the base comprises a uniform thickness. The bracket of the above-noted EXAMPLE where the base comprises a variable thickness. The bracket of the above-noted EXAMPLE where each of the plurality of stiffeners comprises a dimension which tapers to a smaller dimension as the plurality of stiffeners extend upward from the base. The bracket of the above-noted EXAMPLE includes a collar extending upward from the base and configured to have interior horizontal dimensions substantially equal to exterior horizontal dimensions of the column. The bracket of the above-noted EXAMPLE where the collar comprises a top profile configured to attach to the exterior of the column by welding. The bracket of the above-noted EXAMPLE where a height of the collar is variable. The bracket of the above-noted EXAMPLE where the base comprises a plurality of ribs on a top surface of the base configured to increase a bending stiffness and/or strength of the base. The bracket of the above-noted EXAMPLE where a bottom surface of the base is flat and configured to be parallel to a top surface of the foundation. The bracket of the above-noted EXAMPLE where each of the plurality of holes passes through one of the plurality of stiffeners. The bracket of the above-noted EXAMPLE where the bracket comprises a cast construction. The bracket of the above-noted EXAMPLE where the bracket comprises a forged construction. The bracket of the above-noted EXAMPLE where the bracket comprises a 3D printed construction. The bracket of the above-noted EXAMPLE where the bracket is formed by casting. The bracket of the above-noted EXAMPLE where the bracket is formed by forging. The bracket of the above-noted EXAMPLE where the bracket is formed by 3D printing. The bracket of the above-noted EXAMPLE where the bracket is formed by casting, forging, or 3D printing. The bracket of the above-noted EXAMPLE where the bracket is made of steel. The bracket of the above-noted EXAMPLE where the base comprises a rim that extends upward from the base around an outer edge of the base and is configured to increase a stiffness of the base. The bracket of the above-noted EXAMPLE where each of the plurality of stiffeners comprise a cylinder shaped construction. The bracket of the above-noted EXAMPLE where each cylinder further comprises a nut bearing surface configured to form a seat for each of a plurality of nuts. The bracket of the above-noted EXAMPLE where nut bearing surfaces surround each of the plurality of holes. The bracket of the above-noted EXAMPLE where the bracket is configured such that a plurality of nuts can be threaded with the rods extending from the foundation. The bracket of the above-noted EXAMPLE where each cylinder further comprises a nut bearing surface configured to form a seat for each of a plurality of nuts; where each of the nut bearing surfaces surround each of the plurality of holes; and where the bracket is configured such that the plurality of nuts can be threaded with the rods extending from the foundation. The bracket of the above-noted EXAMPLE where each of the plurality of stiffeners comprise a cylinder comprising one of the plurality of holes configured to receive the rods extending from the foundation.

One EXAMPLE: a bracket includes a base. The bracket in addition includes a collar extending upward from the base and configured to have interior horizontal dimensions substantially equal to exterior horizontal dimensions of the column. The bracket moreover includes where the base comprises a plurality of holes around a perimeter of the base. The bracket also includes where each of the plurality of holes are configured to receive corresponding rods extending from the foundation. The bracket further includes where the base is substantially flat and configured to be in contact with the bottom of the column.

The above-noted EXAMPLE may further include any one or a combination of more than one of the following EXAMPLES: The bracket of the above-noted EXAMPLE where the base is configured to be in direct contact with the bottom of the column. The bracket of the above-noted EXAMPLE includes a plurality of stiffeners extending upward from the base, where each of the plurality of stiffeners comprises at least one face configured to attach to an exterior of the column. The bracket of the above-noted EXAMPLE where each of the plurality of stiffeners have at least one weld edge configured to attach the plurality of stiffeners to the exterior of the column by welding. The bracket of the above-noted EXAMPLE where each of the plurality of stiffeners comprises a dimension which tapers to a smaller dimension as the plurality of stiffeners extend upward from the base. The bracket of the above-noted EXAMPLE where each of the plurality of holes passes through one of the plurality of stiffeners. The bracket of the above-noted EXAMPLE where each of the plurality of stiffeners comprise a cylinder shaped construction. The bracket of the above-noted EXAMPLE where each cylinder further comprises a nut bearing surface configured to form a seat for each of a plurality of nuts. The bracket of the above-noted EXAMPLE where nut bearing surfaces surround each of the plurality of holes. The bracket of the above-noted EXAMPLE where the bracket is configured such that a plurality of nuts can be threaded with the rods extending from the foundation. The bracket of the above-noted EXAMPLE where each cylinder further comprises a nut bearing surface configured to form a seat for each of a plurality of nuts; where each of the nut bearing surfaces surround each of the plurality of holes; and where the plurality of nuts are configured to be threaded with the rods extending from the foundation. The bracket of the above-noted EXAMPLE where each of the plurality of stiffeners comprise a cylinder comprising one of the plurality of holes configured to receive the rods extending from the foundation. The bracket of the above-noted EXAMPLE where the base further comprises a plurality of nut bearing surfaces configured to form a seat for each of a plurality of nuts. The bracket of the above-noted EXAMPLE where each of the nut bearing surfaces surround each of the plurality of holes. The bracket of the above-noted EXAMPLE where the bracket is configured such that a plurality of nuts can be threaded with the rods extending from the foundation. The bracket of the above-noted EXAMPLE where the base further comprises a plurality of nut bearing surfaces configured to form a seat for each of a plurality of nuts; where each of the nut bearing surfaces surround each of the plurality of holes; and where the bracket is configured such that the plurality of nuts can be threaded with the rods extending from the foundation. The bracket of the above-noted EXAMPLE where the base comprises a uniform thickness. The bracket of the above-noted EXAMPLE where the base comprises a variable thickness. The bracket of the above-noted EXAMPLE where the collar comprises a top profile configured to attach to an exterior of the column by welding. The bracket of the above-noted EXAMPLE where a height of the collar is variable. The bracket of the above-noted EXAMPLE where the base comprises a plurality of ribs on a top surface of the base configured to increase a bending stiffness and/or strength of the base. The bracket of the above-noted EXAMPLE where a bottom surface of the base is flat and configured to be parallel to a top surface of the foundation. The bracket of the above-noted EXAMPLE where the bracket comprises a cast construction. The bracket of the above-noted EXAMPLE where the bracket comprises a forged construction. The bracket of the above-noted EXAMPLE where the bracket comprises a 3D printed construction. The bracket of the above-noted EXAMPLE where the bracket is formed by casting. The bracket of the above-noted EXAMPLE where the bracket is formed by forging. The bracket of the above-noted EXAMPLE where the bracket is formed by 3D printing. The bracket of the above-noted EXAMPLE where the bracket is formed by casting, forging, or 3D printing. The bracket of the above-noted EXAMPLE where the bracket is made of steel. The bracket of the above-noted EXAMPLE where the base comprises a rim that extends upward from the base around an outer edge of the base and is configured to increase a stiffness of the base.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1. A bracket for connecting a bottom of a column to a foundation comprising:
a base; and
a plurality of stiffeners extending upward from the base,
wherein each of the plurality of stiffeners comprises at least one face configured to attach to an exterior of the column;
wherein the base comprises a plurality of holes around a perimeter of the base;
wherein each of the plurality of holes are configured to receive corresponding rods extending from the foundation; and
wherein the base is substantially flat and configured to be in contact with the bottom of the column.

2. The bracket of claim 1, wherein the base is configured to be in direct contact with the bottom of the column.

3. The bracket of claim 1, wherein the base further comprises a plurality of nut bearing surfaces configured to form a seat for each of a plurality of nuts.

4. The bracket of claim 3, wherein each of the nut bearing surfaces surround each of the plurality of holes.

5. The bracket of claim 1, wherein the bracket is configured such that a plurality of nuts can be threaded with the rods extending from the foundation.

6. (canceled)

7. The bracket of claim 1, wherein each of the plurality of stiffeners have at least one weld edge configured to attach the stiffeners to the exterior of the column by welding.

8. (canceled)

9. (canceled)

10. The bracket of claim 1, wherein each of the plurality of stiffeners comprises a dimension which tapers to a smaller dimension as the plurality of stiffeners extend upward from the base.

11. The bracket of claim 1, further comprising a collar extending upward from the base and configured to have interior horizontal dimensions substantially equal to exterior horizontal dimensions of the column.

12. The bracket of claim 11, wherein the collar comprises a top profile configured to attach to the exterior of the column by welding.

13. (canceled)

14. The bracket of claim 1, wherein the base comprises a plurality of ribs on a top surface of the base configured to increase a bending stiffness and/or strength of the base.

15. The bracket of claim 1, wherein a bottom surface of the base is flat and configured to be parallel to a top surface of the foundation.

16. The bracket of claim 1, wherein each of the plurality of holes passes through one of the plurality of stiffeners.

17. The bracket of claim 1, wherein the bracket comprises a cast construction.

18. The bracket of claim 1, wherein the bracket comprises a forged construction.

19. The bracket of claim 1, wherein the bracket comprises a 3D printed construction.

20.-24. (canceled)

25. The bracket of claim 1, wherein the base comprises a rim that extends upward from the base around an outer edge of the base and is configured to increase a stiffness of the base.

26. The bracket of claim 1, wherein each of the plurality of stiffeners comprise a cylinder shaped construction.

27. The bracket of claim 1, wherein each of the plurality of stiffeners comprise a cylinder comprising one of the plurality of holes configured to receive the rods extending from the foundation.

28. The bracket of claim 26, wherein each cylinder further comprises a nut bearing surface configured to form a seat for each of a plurality of nuts.

29.-31. (canceled)

32. A bracket for connecting a bottom of a column to a foundation comprising:
a base; and
a collar extending upward from the base and configured to have interior horizontal dimensions substantially equal to exterior horizontal dimensions of the column,
wherein the base comprises a plurality of holes around a perimeter of the base;
wherein each of the plurality of holes are configured to receive corresponding rods extending from the foundation; and
wherein the base is substantially flat and configured to be in contact with the bottom of the column.

33.-62. (canceled)
